(19) United States
(12) Patent Application Publication
(10) Pub. No.: US 2011/0044715 A1
(43) Pub. Date: Feb. 24, 2011

(54) IMAGE FORMING DEVICE, OPERATING DEVICE FOR SETTING THE IMAGE FORMING DEVICE AND METHOD OF SETTING THE IMAGE FORMING DEVICE

(75) Inventor: Katsuki Ogata, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/859,561

(22) Filed: Aug. 19, 2010

Related U.S. Application Data
(60) Provisional application No. 61/236,214, filed on Aug. 24, 2009.

(51) Int. Cl. G03G 15/00

(52) U.S. Cl. 399/81

(57) ABSTRACT

According to one embodiment, an image forming device has an image forming unit, a plurality of discharge units, a display unit, a discharge unit button, a discharge setting unit, and a control unit. The plurality of discharge units discharge the image forming medium on which the image is formed by the image forming unit. The display unit displays a setting screen of an image forming process by the image forming unit. The discharge unit button is a button for selecting one discharge unit from the plurality of discharge units. Whenever the discharge unit button is pressed, the discharge setting unit sequentially sets the discharge unit selected depending on setting contents of the image forming process and the discharge unit sequentially selected from the plurality of discharge units. The control unit displays information, which shows the discharge unit set by the discharge setting unit, on the setting screen.

### CROSS-REFERENCE TO RELATED APPLICATIONS

This application is based upon and claims the benefit of priority from U.S. Provisional Application No. 61/236,214 filed on Aug. 24, 2009; the entire contents of which are incorporated herein by reference.

### FIELD

Embodiments described herein relate generally to an image forming device, an operating device for setting the image forming device and a method of setting the image forming device.

### BACKGROUND

An image forming device such as a digital multi-functional peripheral has a plurality of discharge trays for discharging a medium with an image formed thereon. The image forming device discharges the medium with the image formed thereon to any one of the plurality of discharge trays according to a user's instructions. It is required that the user can effectively set a desired discharge tray in the image forming device having the plurality of discharge trays.

### BRIEF DESCRIPTION OF THE DRAWINGS

FIG. 1 is an exterior diagram showing a configuration example of a digital multi-functional peripheral.

FIG. 2 is a sectional view showing the configuration example of the digital multi-functional peripheral.

FIG. 3 is a diagram showing a configuration example of a control panel.

FIG. 4 is a block diagram for illustrating a configuration example of a control system in the digital multi-functional peripheral.

FIG. 5 is a display example of a basic setting screen in a copy mode when the setting of the discharge tray is an automatic setting mode.

FIG. 6 is a display example of a basic setting screen when the discharge tray is set to be a discharge tray in a main body of a digital multi-functional peripheral.

FIG. 7 is a display example of a basic setting screen when the discharge tray is set to be a discharge tray in an upper part of a finisher.

FIG. 8 is a display example of a basic setting screen when the discharge tray is set to be a discharge tray capable of carrying out a finishing process.

FIG. 9 is another display example of a basic setting screen when the discharge tray in the upper part of the finisher is set.

FIG. 10 is another display example of a basic setting screen when the discharge tray in the main body of the digital multi-functional peripheral is set as the discharge tray.

FIG. 11 is a display example which displays a basic setting screen in an automatic setting mode when the finishing process is set.

FIG. 12 is a display example which displays a basic setting screen directly designating the discharge tray when the finishing process is set.

FIG. 13 is a flow chart for illustrating a flow of the setting process of the discharge tray.

### DETAILED DESCRIPTION

In general, according to one embodiment, an image forming device has an image forming unit, a plurality of discharge units, a display unit, a discharge unit button, a discharge setting unit, and a control unit. The image forming unit forms an image on an image forming medium. The plurality of discharge units discharge the image forming medium on which the image is formed by the image forming unit. The display unit displays a setting screen of an image forming process by the image forming unit. The discharge unit button is a button for selecting one discharge unit from the plurality of discharge units. Whenever the discharge unit button is pressed, the discharge setting unit sequentially sets the discharge unit selected depending on the setting content of the image forming process and the discharge unit sequentially selected from the plurality of discharge units. The control unit displays information showing the discharge unit set by the discharge setting unit on the setting screen.

Hereinafter, embodiments will be described with reference to the drawings.

Firstly, a configuration of a digital multi-functional peripheral (MFP, Multi-functional Peripheral) as the image forming device will be described.

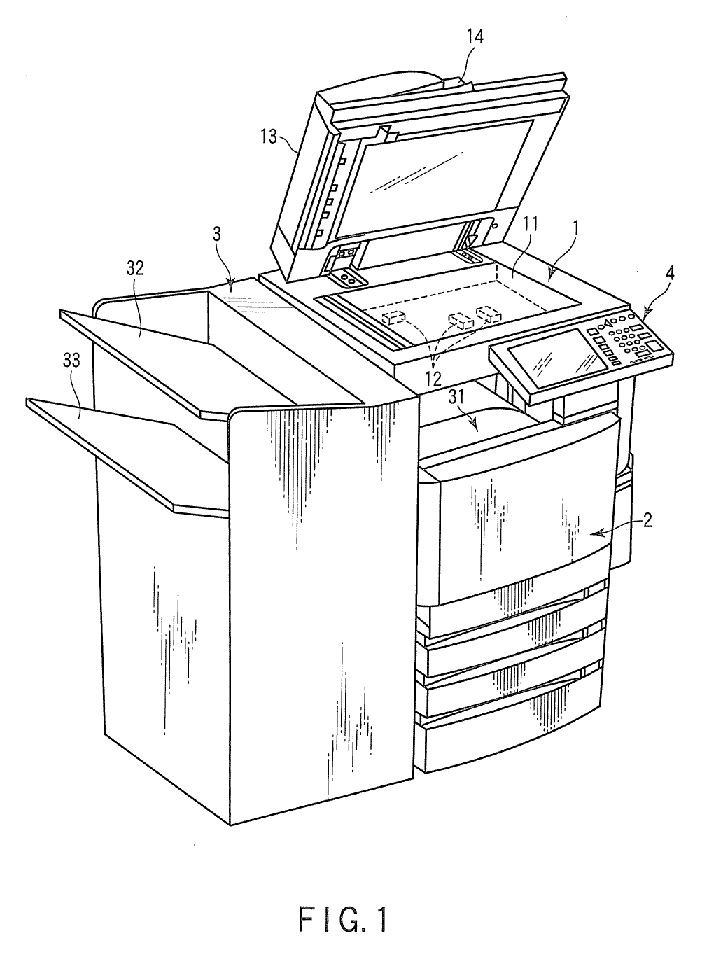

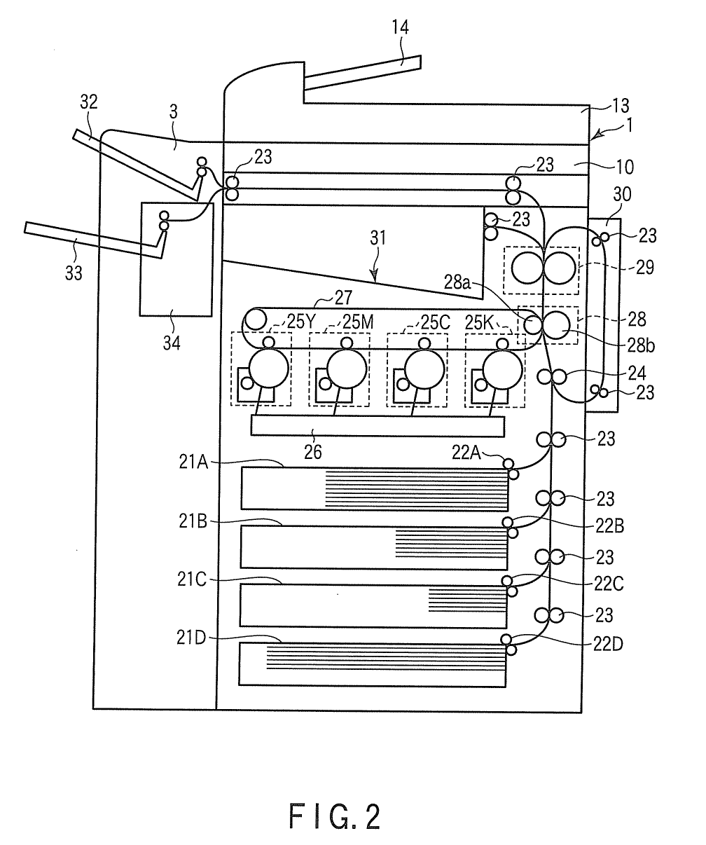

FIG. 1 is a perspective view showing an exterior configuration example of the digital multi-functional peripheral. Furthermore, FIG. 2 is a sectional view which schematically shows an interior configuration example of the digital multi-functional peripheral. As shown in FIG. 1, the digital multi-functional peripheral has a scanner 1, a printer 2, a finisher 3, and a control panel 4.

The scanner 1 is installed in an upper part of a main body of the digital multi-functional peripheral. The scanner 1 is a device which optically reads an image of an original document. The scanner 1 has an image reading unit 10 as a photoelectric conversion unit including a CCD line sensor which converts the image of one line of a main scanning direction in the original document into image data. The image reading unit 10 reads the image of the overall original document by scanning the original document in a sub scanning direction of the original document with the CCD line sensor.

The scanner 1 has an original document mounting glass 11 and an original document sensor 12. The original document to be scanned by the image reading unit 10 is placed on the original document mounting glass 11. The image reading unit 10 scans the original document on the original document mounting glass 11 via the glass of the original document mounting glass 11. The original document sensor 12 detects the original document on the original document mounting glass 11. The original document sensor 12 outputs a signal showing whether or not the original document exists on the original document mounting glass 11. The original document sensor 12 detects the size of the original document on the original document mounting glass 11.

The scanner 1 has an automatic original document feeding device (ADF: Auto document Feeder) 13. The ADF 13 has a paper feeding tray 14. The paper feeding tray 14 holds the original document to be read. The ADF 13 transports the original document which is held by the paper feeding tray 14, one sheet at a time. The scanner 1 reads the image of the original document which is transported by the ADF 13. In the scanner 1, the ADF 13 also serves as a cover in regard to the original document placed on the original document mounting glass 11. The ADF 13 is attached on the original document mounting glass 11 in the main body of the digital multi-functional peripheral in the state where the whole of which can be opened and closed.

The printer 2 has paper feeding cassettes 21A, 21B, 21C, and 21D. The paper feeding cassettes 21A, 21B, 21C and 21D receive the paper as image forming medium which prints the image. For example, the paper feeding cassettes 21A, 21B, 21C and 21D can be attached to and detached from a lower part of the digital multi-functional peripheral main body. The respective paper feeding cassettes 21A, 21B, 21C and 21D have paper feeding rollers 22A, 22B, 22C and 22D, respectively. The respective paper feeding rollers 22A, 22B, 22C and 22D take out the paper from the respective paper feeding cassettes 21A, 21B, 21C and 21D one sheet at a time.

A transport unit 23 transports the paper within the printer 2. The transport unit 23 has a plurality of transport rollers and resist rollers 24. The transport unit 23 transports the paper, which is taken out by the respective paper feeding rollers 22A, 22B, 22C and 22D, to the resist rollers 24. The resist rollers 24 transport the paper to a transfer position at the timing when the image is transferred.

A plurality of image forming units 25 (25Y, 25M, 25C, and 25K) form images of each color (yellow, magenta, cyan, and black), respectively. A light exposure unit 26 forms an electrostatic latent image as the image which is developed by each color in an image carrier in the respective image forming units 25 (25Y, 25M, 25C, and 25K). An intermediate transfer belt 27 is an intermediate transfer body. The respective image forming units 25 (25Y, 25M, 25C, and 25K) form a toner image on the intermediate transfer belt 27 by developing the electrostatic latent image with toners of the respective colors (yellow, magenta, cyan, and black).

The respective image forming units 25Y, 25M, 25C, and 25K transfer the toner image developed by the toners of the respective colors (yellow, magenta, cyan, and black) onto the intermediate transfer belt 27 in an overlapping manner (primary transfer). The intermediate transfer belt 27 holds the color image in which the toner images of each color are overlapped. A transfer unit 28 transfers the color image with the plurality of colors of toners which is on the intermediate transfer belt 27 onto the paper at a secondary transfer position. The secondary transfer position is a position where the toner image on the intermediate transfer belt 27 is transferred onto the paper. The secondary transfer position is a position where a support roller 28a and a second transfer roller 28b face each other. The resist rollers 24 transport the paper to the secondary transfer position so as to match the timing of the toner images on the intermediate transfer belt 27.

The transfer unit 28 supplies the paper, onto which the toner image is transferred, to a fixing unit 29. The fixing unit 29 fixes the toner image to the paper. The fixing unit 29 heats the paper, onto which the toner image is transferred by the transfer unit 28, in a pressured state. The fixing unit 29 transports the paper subjected to fixing to a reverse unit 30, a paper discharge unit 31 or the finisher 3. The reverse unit 30 is used in double-sided printing. The reverse unit 30 reverses the sides of the paper. The reverse unit 30 again supplies the paper in which the sides have been reversed to the resist rollers 24. The paper discharge unit 31 is a discharge tray which holds the discharged paper.

Moreover, the printer 2 shown in FIG. 2 is an electro photographic type of printer. However, the printer of the present embodiment is not limited to the electro photographic type. For example, the present embodiment can also be applied to a printer other than the electro photographic type such as an ink jet type or a thermal transfer type.

The finisher 3 has a discharge tray 32 and a discharge tray 33 for accumulating the paper on which the image is formed by the printer 2. The discharge tray 32 is at an upper part of the finisher 3. The discharge tray 33 has a finishing process unit 34 for processing the paper on which the image is formed by the printer 2. The finishing process unit 34 has a drive unit, a stapling unit, and a hole punch. The drive unit drives the discharge tray 33. The staple unit performs the stapling of the paper on the discharge tray 33. The hole punch unit forms punch holes in the paper on the discharge tray 33.

The control panel 4 is a user interface. The control panel 4 displays instructions or receives the input of an operation button or an icon. For example, the user inputs setting information into the control panel 4.

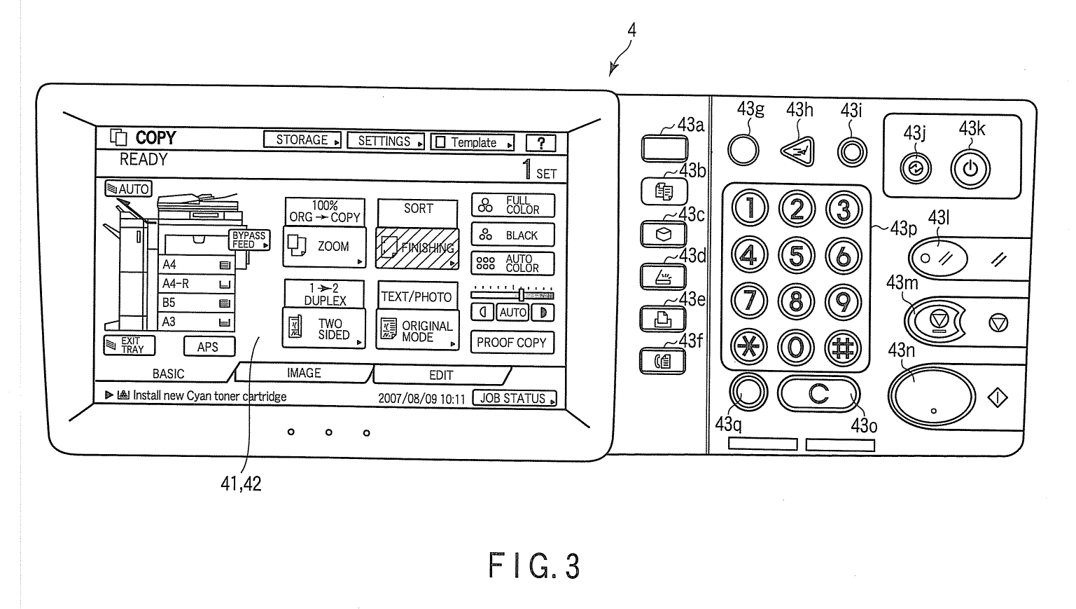

FIG. 3 is a diagram showing a configuration example of the control panel 4. In the example shown in FIG. 3, the control panel 4 has a display device 41, a touch panel 42 and a plurality of operation buttons 43 (43a to 43p). The display device 41 displays the instructions. The display device 41 has the touch panel 42 on the display screen. The touch panel 42 detects a part which is touched by the user on the display screen of the display device 41. The user can select an icon, which is displayed by the display device 41, by the touch panel 42.

The plurality of operation buttons 43 have a menu button 43a, an operation mode selection button (a copy button 43b, a filing box button 43c, a scanner button 43d, a print button 43e, and a facsimile button 43f), a setting registration button (a setting button) 43g, an interruption button 43h, a counter button 43i, an energy-saving button 43j, a power supply button 43k, a resetting button 43l, a stop button 43m, a start button 43n, a clear button 43o, ten keys 43p, a certification button 43q and the like.

The menu button 43a is a button for specifying the display of the menu screen. When the menu button 43a is pressed, the display device 41 displays a frequently used template. The copy button 43b is a button for specifying a copy mode as an operation mode. The filing box button 43c is a button for specifying the retrieving of stored image data. The scan button 43d is a button for specifying the scan mode as the operation mode. The print button 43e is a button for specifying the print mode as the operation mode for a private printing and the like. The facsimile button 43f is a button for specifying the facsimile mode as the operation mode.

For example, when the user presses the copy button 43b, the digital multi-functional peripheral enters the copy mode. When the digital multi-functional peripheral is the copy mode, the display device 41 displays the copy setting screen. Immediately after the copy button 43b is pressed, the display button 41 displays the copy setting screen in which a default setting of the copy mode is reflected. In the state in which the copy setting screen is displayed, the user can change the setting content to a desired setting content. For example, the number of copies can be changed by pressing the ten keys 43p. When the start button 43n is pressed, the digital multi-functional peripheral carries out the copying by the setting contents displayed on the display device 41.

The setting button 43g is a button for specifying when the setting value is registered. For example, when the setting button 43g is pressed, the user can set and register the setting time for auto clearing the setting contents (set auto clearing time), the changing of a language which is displayed by an instruction screen and the like, the adjusting of brightness of the display screen of the display device, the adjusting of gradation correction of the toner image, the adjusting of positioning of the toner image relative to the paper and the like. The setting values such as the default values, which are set by the user after the setting button 43g is pressed, are stored in a memory 51 within a system control unit 5 described later.

The interruption button 43h is a button which temporarily stops the printing which is being executed and instructs the execution of a separate process. The counter button 43i is a button for specifying the display of the counter. The energy-saving button 43j is a button for specifying the energy-saving mode as the operation mode. The power supply button 43k is a button for specifying the turning ON of the power supply. The power supply button 43k may be a button for specifying shut down. The resetting button 43l is a button for clearing the setting contents and specifying a return to an initial setting. The stop button 43m is a button for specifying the stopping of the operation. The start button 43n is a button for specifying the start of the operation such as copying, scanning and facsimile. The clear button 43o is a button for specifying the correction of numerical values such as the number of copies which is input by the ten keys 43p. The ten keys 43p are buttons for inputting numerical values such as the number of copies.

The certification button 43q is a button for performing user certification. For example, when a function requiring user certification is used, the user presses the certification button 43q. When the user presses the certification button 43q, the system control unit of the digital multi-functional peripheral carries out the user certification process. For example, the user certification process is a process which compares certification information input by the user (for example, information such as a password or vital information) with certification information in a register. When user certification by the user certification process is successful, for example, the display device 41 displays the setting screen for the user.

A configuration of the control system of the digital multi-functional peripheral configured as described above will be described.

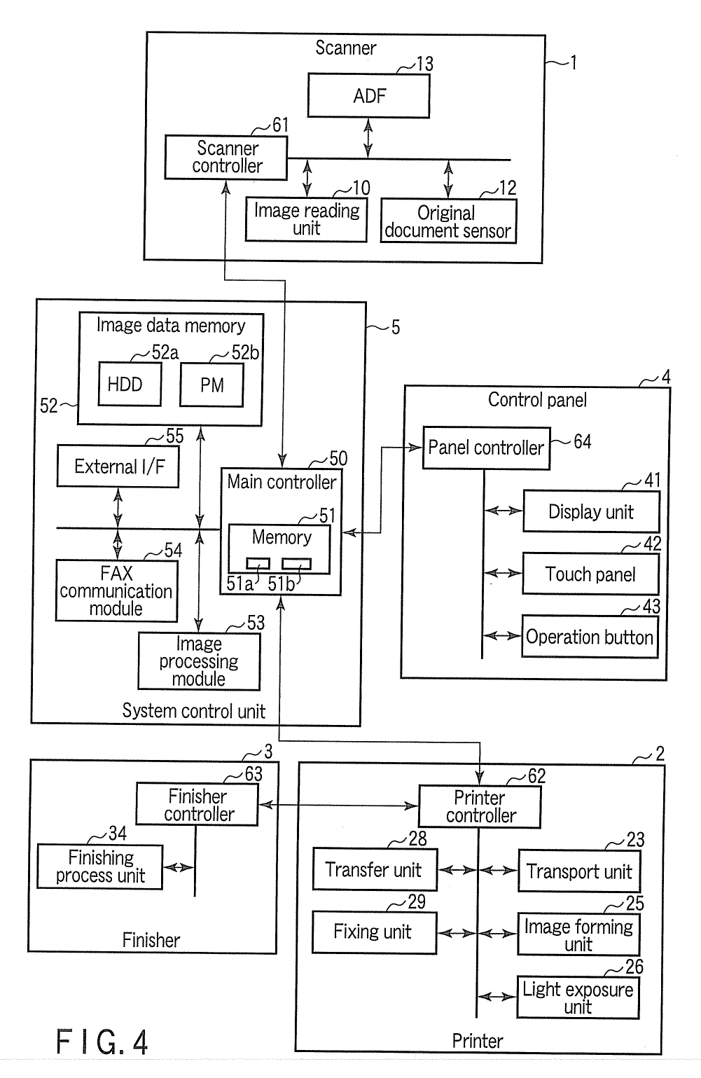

FIG. 4 is a block diagram for illustrating a configuration example of a control system in the digital multi-functional peripheral.

The digital multi-functional peripheral has the system control unit 5 for controlling the entire device. The system control unit 5 is connected to the scanner 1, the printer 2, the finisher 3 and the control panel 4. The system control unit 5 collectively controls the scanner 1, the printer 2, the finisher 3 and the control panel 4.

The system control unit 5 has a main controller (a processor) 50, an image data memory 52, an image processing module 53, a FAX communication module 54, an external interface (NW I/F) 55 or the like.

The main controller 50 controls the entire digital multi-functional peripheral. The main controller 50 has, for example, the processor, a RAM and a ROM. The main controller 50 is connected to the scanner 1, the printer 2, and the control panel 4. The main controller 50 outputs the operation instructs to the respective units or acquires various information from the respective units by two-way communication with the scanner 1, the printer 2, and the control panel 4. For example, the main controller 50 outputs setting information to the respective units based on the present valid setting contents. The main controller 50 inputs information which shows the detection signals, the operation state of the sensors and the like from the respective units.

The main controller 50 has the memory 51 for storing setting information and the like. The memory 51 includes a rewritable nonvolatile memory, a volatile memory (a working memory) and the like. The rewritable nonvolatile memory stores control programs, control data, setting information and the like. The volatile memory serves as a working memory which stores information showing the operation state or temporarily stores working data.

The image data memory 52 has a hard disk drive (HDD) 52a and a page memory (PM) 52b. The HDD 52a is a large capacity memory device. For example, the HDD 52a stores a plurality of image data. In the HDD 52a, other than the image data, also setting data, control program and the like may be stored. The page memory 52b is a memory for developing the image data to be processed. The image processing module 53 processes the image data. The image processing module 53 corrects, compresses or expands the image data. The FAX communication module 54 transmits and receives the facsimile data. The external interface 55 is an interface which performs data communication with an external device. For example, the external interface 55 inputs the image data for printing from the external device.

The scanner 1 has a scanner controller 61. The scanner controller 61 can communicate with the main controller 50 of the system control unit 5. The scanner controller 61 controls the image reading unit 10 and the ADF 13. The processor executes the control program stored in the memory, whereby the scanner controller 61 controls the respective units within the scanner 1. The scanner controller 61 outputs the image data read by the image reading unit 10 to the system control unit 5.

The printer 2 has a printer controller 62. The printer controller 62 can communicate with the main controller 50 of the system control unit 5. The printer controller 62 controls the transport unit 23, the image forming unit 25, the light exposure unit 26, the transfer unit 28, and the fixing unit 29 within the printer 2. The processor executes the control program stored in the memory, whereby the printer controller 62 controls the respective units within the printer 2. The printer controller 62 notifies the processing situation of the respective units within the printer 2 to the main controller 50 of the system control unit 5. In addition, the printer controller 62 can communicate with a finisher controller 63 of the finisher 3. The printer controller 62 outputs the operation instructs to the finisher 3 or acquires various information from the finisher 3.

The finisher 3 has the finisher controller 63. The finisher controller 63 can communicate with the printer controller 62 of the printer 2. The finisher controller 63 controls the finishing process unit 34 within the finisher 3. The finisher controller 63 performs the drive control of various mechanisms within the finisher 3 by the processor executing the control program stored in the memory. The finisher controller 63 notifies the processing situation of the finisher 3 to the printer 2.

The control panel 4 has a panel controller 64. The panel controller 64 can communicate with the main controller 50 of the system control unit 5. The panel controller 64 is connected to the display device 41, the touch panel 42, and the operation button 43. The panel controller 64 controls the display screen displayed by the display device 41. The panel controller 64 detects the display part such as an icon, which is touched by the user, by the detection signal from the touch panel 42. The panel controller 64 outputs information, which indicates the icon that is displayed on the display part and which is touched by the user, to the main controller 50. The panel controller 64 outputs the signal indicating the operation button 43 specified by the user to the main controller 50.

Next, the setting of the discharge tray in the digital multi-functional peripheral will be described.

The digital multi-functional peripheral having the above-mentioned configuration has the three discharge trays 31, 32 and 33. When the image forming process is performed, the main controller 50 determines on one discharge tray from the three discharge trays. The user can directly designate one discharge tray (a manual setting mode and a direct designation mode). Furthermore, the user can designate the mode (automatic setting mode) in which the digital multi-functional peripheral selects one discharge tray depending on the setting contents of the printing process.

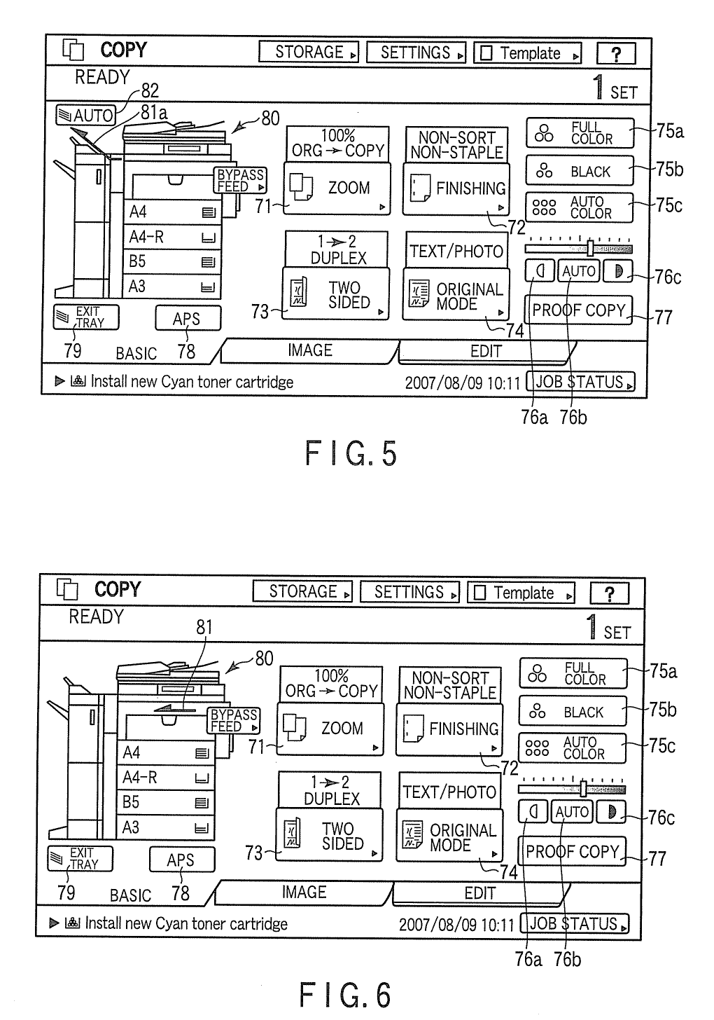

FIG. 5 is a display example of a basic setting screen in the copy mode. When the digital multi-functional peripheral is in the copy mode, the display unit 41 of the control panel 4 displays the setting screen as shown in FIG. 5 as the basic setting screen. The basic setting screen shown in FIG. 5 has a plurality of operation buttons (icons), illustrations showing the overall digital multi-functional peripheral, instructions showing the operation state and the setting state and the like.

In the display example shown in FIG. 5, as the operation button for setting the processing content (copy condition) of the printing, the display unit 41 displays a magnification button 71, a finishing button 72, a double sides button 73, an original document mode button 74, color mode buttons 75a, 75b and 75c, concentration setting buttons 76a, 76b and 76c, a trial copy button 77, an APS button 78 and a discharge tray button 79.

The magnification button 71 is an icon for displaying “magnification”. When setting the copy magnification, the user presses the magnification button 71. When the user presses the magnification button 71, the display unit 41 displays the magnification setting screen. Furthermore, in a basic setting screen, the display unit 41 displays the setting value of the current copy magnification in an area adjacent to the magnification button 71.

The finishing button 72 is an icon which is displayed as “finishing”. When setting the finishing process (stapling, the hole punch, electronic sorting and the like), the user presses the finishing button 72. When the user presses the finishing button 72, the display unit 41 displays the finishing process setting screen. Moreover, in the basic setting screen, the display unit 41 displays the setting state of the current finishing process in the area adjacent to the finishing button 72.

The double sided button 73 is an icon which is displayed as “double sided”. When setting double-sided copying, the user presses the double sided button 73. When the user presses the double sided button 73, the display unit 41 displays the double-sided copying setting screen. In addition, in the basic setting screen, the display unit 41 displays the setting state of the current double-sided copying in the area adjacent to the double sided button 73.

The original document mode button 74 is an icon displayed as “original document mode”. When setting the original document mode (e.g., a letter original document, a photograph original document, a letter photograph original document and the like), the user presses the original document mode button 74. When the user presses the original document mode button 74, the display unit 41 displays the original document mode setting screen. In addition, in the basic setting screen, the display unit 41 displays the setting state of the current original document mode in the area adjacent to the original document mode button 74.

The color mode buttons 75a, 75b and 75c are buttons for selecting the color mode. When selecting the full color copy, the user sets the full color button 75a to be the selection state. When the white and black copying is selected, the user sets the black color button 75b to be the selection state. When the setting of the color or black and white is automatically set, the user sets the automatic color button 75c to be the selection state.

The concentration setting buttons 76a, 76b and 76c are buttons for setting the concentration. When setting the concentration to be low, the user presses the concentration down button 76a. When setting the concentration to be high, the user presses the concentration up button 76c. When setting the concentration automatically, the user presses the automatic concentration button 76b. The trial copy button 77 is a button for specifying a trial copy in the current setting contents. The APS button 78 is a button showing an automatic detection of the size of the original document. When the APS button is in a selection state, the automatic size detection is effective.

The discharge tray button 79 is a button by which the user selects the discharge tray for discharging the printed (copied) paper. The display unit 41 displays the discharge tray button 79 as an icon displayed as “discharge tray” that can be selected by the touch panel 42. Moreover, the discharge tray button 79 is not limited to that which is displayed by the icon, but may be a hard key and the like. When changing (setting) the discharge tray, the user presses the discharge tray button 79. Whenever the discharge tray button 79 is pressed, the main controller 50 changes the setting of the discharge tray. For example, whenever the discharge tray button 79 is pressed, as the setting of the discharge tray, the main controller 50 sequentially changes a discharge tray selected in the automatic setting mode, the discharge tray (a first discharge tray within the main body of the digital multi-functional peripheral) 31, the discharge tray (a second discharge tray in an upper part of the finisher) 32, the discharge tray (a third discharge tray that can execute the finishing process in the middle stage of the finisher) 33.

In the display example of the basic setting screen shown in FIG. 5, the display unit 41 displays an illustration 80. The illustration 80 illustrates the entire digital multi-functional peripheral including the three discharge trays. In the display example shown in FIG. 5, the display unit 41 displays the illustration 80 of the entire digital multi-functional peripheral having the three discharge trays. In the display example of the basic setting screen as shown in FIG. 5, the display unit 41 displays information which shows the size of the paper as the image forming medium received within the respective cassettes in the illustration 80.

The display unit 41 displays the discharge tray, which is set by the discharge tray button 79, on the basic setting screen. In the basic setting screen of the copy mode, the display unit 41 displays marks 81 (81a, 81b and 81c) which show the discharging tray which is currently set in the illustration 80. In the display example shown in FIG. 5, the display unit 41 displays arrows as the mark 81a showing that the discharge tray (the second discharge tray) 32 in the upper part of the finisher 3 is set. The marks 81 showing the set discharge tray are not limited to the arrows. For example, the marks 81 may be an animation. In addition, instead of the marks 81, in the illustration 80, the part of the set discharge tray may be emphasized (for example, the part is displayed in bold or displayed by a color different from other parts).

When the setting of the discharge tray is the automatic setting mode, the display unit 41 displays the marks 81 showing the set discharge tray and an instruction icon 82 showing that the setting of the discharge tray is the automatic setting mode. In the display example shown in FIG. 5, the display unit 41 displays the instruction icon 82 displayed as “automatic” in the display area adjacent to the illustration 80. Furthermore, when displaying the instruction icon 82 (namely, when the discharge tray is the automatic setting mode), the display unit 41 displays the discharge tray button 79 in a non-selection state (e.g., an icon of black letters on the white background). When the instruction icon 82 is not displayed (namely, when the discharge tray is not in the automatic setting mode), the display unit 41 may display the discharge tray button 79 in the selection state (e.g., an icon of white letters (discolored letters) on the black background).

Next, a display example of a basic setting screen in response to the setting of the discharge tray will be described.

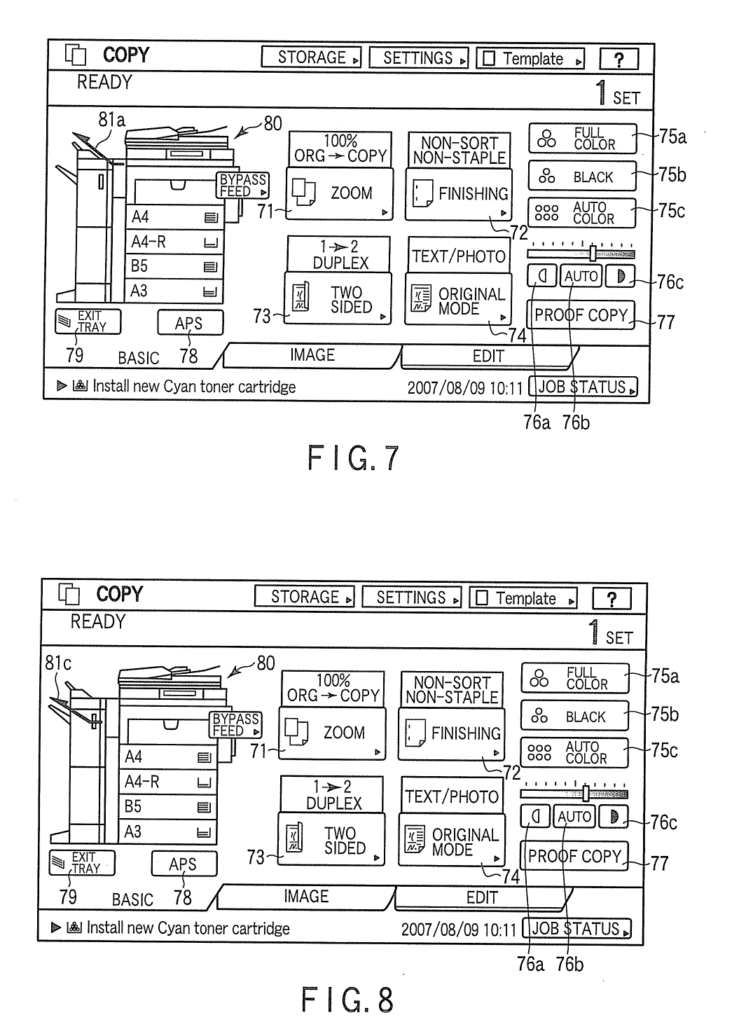

FIGS. 5 to 8 are display examples of basic setting screens in which the settings of the discharge tray are different from each other. FIG. 5 is a display example when the setting of the discharge tray is the automatic setting mode. FIG. 6 is a display example when the setting of the discharge tray is the discharge tray (the first discharge tray) 31 in the main body of the digital multi-functional peripheral. FIG. 7 is a display example when the setting of the discharge tray is the discharge tray (the second discharge tray) 32 in the upper part of the finisher 3. FIG. 8 is a display example when the setting of the discharge tray is the discharge tray (the third discharge tray) 33 capable of carrying out the finishing process such as the stapling, the hole punch or the like.

Whenever the discharge tray button 79 is pressed, in the digital multi-functional peripheral of the present embodiment, the main controller 50 sequentially changes the discharge tray selected at the automatic setting mode, the discharge tray 31, the discharge tray 32 and the discharge tray 33, as the setting of the discharge tray. When the setting of the discharge tray is changed depending on the input to the discharge tray button 19, the display unit 41 displays information showing the setting of the discharge tray which is changed depending on the input to the discharge tray button 19.

For example, the display unit 41 displays the marks 81, which show the discharge tray that is set depending on the input to the discharge tray button 79, on the illustration 80 of the basic setting screen. Furthermore, the display unit 41 displays whether or not the setting of the discharge tray changed depending on the input to the discharge tray button 79 is the automatic setting mode according to existence of the instruction icon 82. That is, depending on the setting of the discharge tray that is changed whenever the user presses the discharge tray button 79, the display unit 41 renews the display of the mark 81 and the instruction icon 82 which show the discharge tray set on the basic setting screen.

Herein, the digital multi-functional peripheral sets the default setting of the discharge tray to be the automatic setting mode. Furthermore, whenever the discharge tray button 79 is pressed, the digital multi-functional peripheral changes the setting of the discharge tray in the order of “the discharge tray selected in the automatic setting mode”, “the discharge tray 31”, “the discharge tray 32”, “the discharge tray 33”, “the discharge tray selected in the automatic setting mode”, “the discharge tray 31”, “the discharge tray 32”, “the discharge tray 33”, . . . . In the digital multi-functional peripheral, the display unit 41 of the control panel 4 renews the basic setting screen in the copy mode to the display screen as shown in FIGS. 5 to 8, whenever the discharge tray button 79 is pressed.

When the setting of the discharge tray is set to be the default setting (herein, the setting is set to be the automatic setting mode of the discharge tray), the display unit 41 displays the instruction icon 82 showing that the setting of the discharge tray is the automatic setting mode, and displays the marks 81 showing the discharge tray selected by the automatic setting mode. FIG. 5 is a display example when the setting of the discharge tray is the automatic setting mode.

In the display example shown in FIG. 5, the display unit 41 displays the instruction icon 82 which displays “automatic” showing that the setting of the discharge tray is the automatic setting mode, and displays the mark (arrow) 81a, which shows the discharge tray (the discharge tray 32 in the example of FIG. 5) selected in the automatic setting mode, at the display position of the discharge tray 32 on the illustration 80 in an overlapping manner. In addition, in the display example shown in FIG. 5, the display unit 41 displays the discharge tray button 79 in the non selection state (the icon of black letters on the white background in the display example shown in FIG. 5). The display unit 41 shows that the discharge tray is the automatic setting (not the directly selected discharge tray), by displaying the discharge tray button 79 in the non selection state.

When the user presses the discharge tray button 79 in the state in which the basic setting screen shown in FIG. 5 is displayed, the main controller 50 changes the setting of the discharge tray from the discharge tray selected in the automatic setting mode to the first discharge tray 31. When the setting of the discharge tray is changed to the first discharge tray 31, the display unit 41 removes the instruction icon 82 showing the automatic setting mode (or instructs and displays that the setting is not the automatic setting mode), and displays the mark 81b showing that the setting of the discharge tray is the first discharge tray 31.

FIG. 6 is a display example when the setting of the discharge tray is changed to the discharge tray 31. In a display example shown in FIG. 6, the display unit 41 does not display the instruction icon 82, but displays the mark (arrow) 81b, which shows that the setting of the discharge tray is the first discharge tray 31, at the display position of the discharge tray 31 on the illustration 80 in an overlapping manner. In addition, in the display example shown in FIG. 6, the display unit 41 displays the discharge tray button 79 in the selection state (an icon of white letters (discolored letters) on the black background in the display example shown in FIG. 6). The display unit 41 shows that the first discharge tray 31 is directly designated by displaying the discharge tray button 79 in the selection state.

When the user presses the discharge tray button 79 in the state in which the basic setting screen shown in FIG. 6 is displayed, the main controller 50 changes the setting of the discharge tray from the discharge tray 31 to the discharge tray 32. When the setting of the discharge tray is changed to the discharge tray 32, the display unit 41 removes the instruction icon 82 showing that the setting of the discharge tray is the automatic setting mode (or displays that the setting is not the automatic setting mode), and displays the mark 81a showing the second discharge tray 32.

FIG. 7 is a display example when the setting of the discharge tray is changed to the discharge tray 32. In a display example shown in FIG. 7, the display unit 41 does not display the instruction icon 82, but displays the mark (arrow) 81a, which shows that the setting of the discharge tray is the second discharge tray 32, at the display position of the discharge tray 32 on the illustration 80 in an overlapping manner. In addition, in the display example shown in FIG. 7, the display unit 41 displays the discharge tray button 79 in the selection state (an icon of white letters (discolored letters) on the black background in the display example shown in FIG. 7). The display unit 41 shows that the second discharge tray 32 is directly designated by displaying the discharge tray button 79 in the selection state.

When the user presses the discharge tray button 79 in the state in which the basic setting screen shown in FIG. 7 is displayed, the main controller 50 changes the setting of the discharge tray from the discharge tray 32 to the discharge tray 33. When the setting of the discharge tray is changed to the discharge tray 33, the display unit 41 removes the instruction icon 82 showing that the setting is the automatic setting mode (or displays that the setting is not the automatic setting mode), and displays the mark 81c showing the third discharge tray 33.

FIG. 8 is a display example when the setting of the discharge tray is changed to the discharge tray 33. In a display example shown in FIG. 8, the display unit 41 does not display the instruction icon 82, but displays the mark (arrow) 81c, which shows that the setting of the discharge tray is the third discharge tray 33, at the display position of the discharge tray 33 on the illustration 80 in an overlapping manner. The display unit 41 shows that the third discharge tray 33 is directly designated by displaying the discharge tray button 79 in the selection state.

When the user presses the discharge tray button 79 in the state in which the basic setting screen shown in FIG. 8 is displayed, the main controller 50 changes the setting of the discharge tray from the discharge tray 33 to the automatic setting mode. When the setting of the discharge tray is changed to the automatic setting mode, as in the display example shown in FIG. 5, the display unit 41 displays the instruction icon 82 showing that the setting is the automatic setting mode, and displays the marks 81 showing the discharge tray which is selected in the automatic setting mode. Moreover, as shown in FIG. 5, the display unit 41 shows that the discharge tray is automatically selected (not the discharge tray which is directly selected by the user) by displaying the discharge tray button 79 in the non selection state.

As described above, whenever the discharge tray button 79 is pressed, the digital multi-functional peripheral changes the setting of the discharge tray in the order of the discharge tray selected by the automatic setting mode, the discharge tray 31, the discharge tray 32, and the discharge tray 33. The control panel of the digital multi-functional peripheral transfers the basic setting screen to be shown on the display unit 41 to the display contents as shown in FIGS. 5 to 8 depending on the change of the setting of the discharge tray. The user can effectively change the setting of the discharge tray only by pressing one discharge tray button, and the setting of the changed discharge tray can be simply confirmed.

Next, the description will be given of another display example when the discharge tray 31 or the discharge tray 32 is set as the discharge tray.

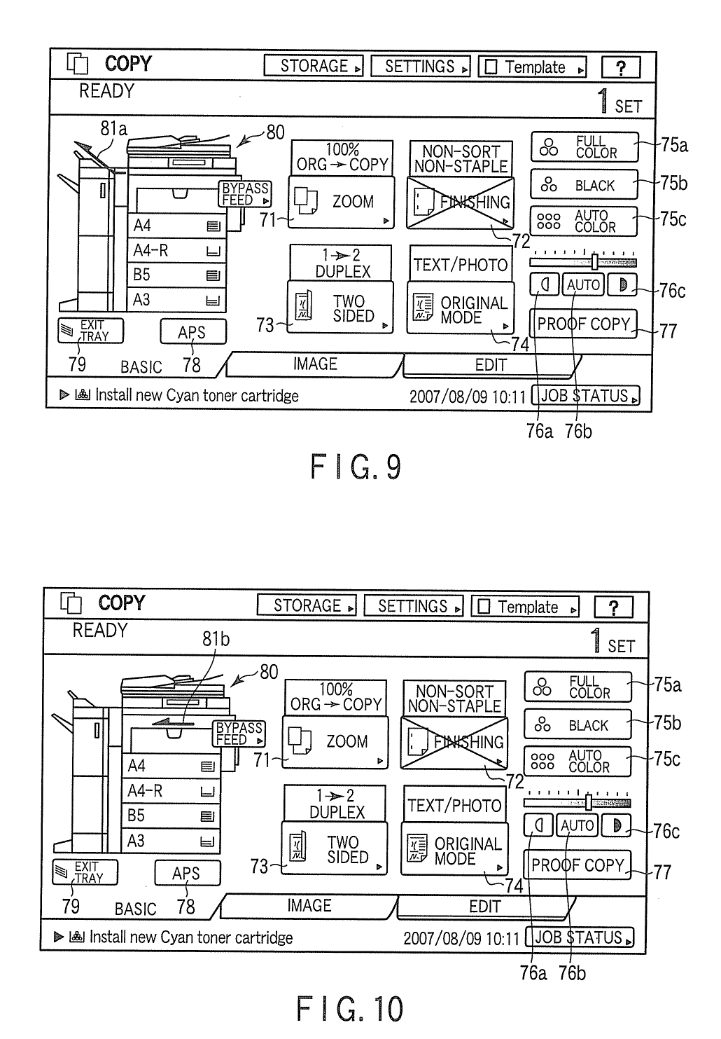

FIG. 9 is another display example of the basic setting screen when the discharge tray 32 in the upper part of the finisher 3 is set as the discharge tray.

When setting the discharge tray 32, the display unit 41 of the control panel 4 may display the instruction which is adapted so that the process, in which the discharge unit of the print result cannot be executed at the discharge tray 32, cannot be set. For example, the finisher 3 carries out the finishing process such as stapling, the hole punch, and electronic sorting, by the discharge tray 33. The finisher 3 cannot execute the finishing process in the setting which discharges the print result to the discharge tray 32. In this case, the display unit 41 displays that the finishing process cannot be set in the state where the discharge tray (the discharge tray 32 in the display example shown in FIG. 9) other than the discharge tray 31 is set.

For example, FIG. 9 is a display example which displays the finishing button 72 for setting the finishing process in the non selectable state. In the display example shown in FIG. 9, the display unit 41 displays the mark showing not selectable on the finishing button 72. In addition, when the discharge tray (namely, the discharge tray in which the finishing process cannot be executed, e.g., the discharge tray 32) other than the discharge tray, in which the finishing process can be executed, is designated, the display unit 41 may display the finishing button 72 so as to be shown in white (to be pale compared to other buttons), and may not display (remove) the finishing button 72.

Furthermore, when the discharge tray (e.g., the discharge tray 32) in which the finishing process cannot be executed is designated, the display unit 41 may display the instructions to the effect that as the discharge tray 32 is set, the finishing process cannot be executed. In addition, when the discharge tray (e.g., the discharge tray 32) in which the finishing process cannot be executed is designated, the display unit 41 may display the instructions to the effect that it is required to change the setting of the discharge tray to the discharge tray 33 to execute (set) the finishing process.

FIG. 10 is another display example of the basic setting screen when the discharge tray 31 within the main body of the digital multi-functional peripheral is set as the discharge tray.

When setting the discharge tray 31, the display unit 41 of the control panel 4 may display the setting screen in which the process, that the discharge unit of the printing result cannot execute in the discharge tray 31, cannot be set. For example, the finishing process cannot be executed in the discharge tray 31 and the paper of A3 size cannot be discharged to the discharge tray 31. In this case, in the state in which the discharge tray 31 is set, the display unit 41 displays that the finishing process cannot be set and the paper of A3 size cannot be selected as the copy paper (the image forming medium). For example, the display unit 41 displays the finishing button 72 for setting the finishing process in the non selectable state, and displays the cassette (hereinafter, referred to as A3 cassette) that receives the paper of A3 size in the non selectable state.

In the display example shown in FIG. 10, the display unit 41 displays the mark showing that the finishing button 72 and the A3 cassette cannot be selected. When the discharge tray 31 is designated, the display unit 41 may display the finishing button 72 and the A3 cassette to be shown in white (to be pale compared to other buttons), and may not display (remove) the finishing button 72 and the A3 cassette.

In addition, when the discharge tray 31 is designated, the display unit 41 may display the instructions to the effect that the selection of the finishing process and the A3 paper cannot be selected as the discharge tray 31 is set. Furthermore, when the discharge tray 31 is designated, the display unit 41 may display the instructions to the effect that a change of the setting of the discharge tray to the discharge tray 33 is required to execute (set) the finishing process, and may display the instructions to the effect that a change of the setting of the discharge tray to the discharge tray 32 or 33 is required to select the A3 cassette.

Furthermore, even when the discharge tray 31 or the discharge tray 32 is designated, the finishing button 72 may be displayed in the selectable state as shown in FIG. 6 or 7. For example, when the finishing button 72 is selected in the setting screen as shown in FIG. 6 or 7, the main controller 50 may forcibly change the setting of the discharge tray to the discharge tray 33.

Moreover, even when the discharge tray 31 is designated, as shown in FIG. 6, the A3 cassette can be set. For example, in the setting screen as shown in FIG. 6, when the A3 cassette is selected, the main controller 50 may forcibly change the setting of the discharge tray to the discharge tray 32 or the discharge tray 33.

As described above, when the setting of the discharge tray is changed depending on the input to the discharge tray button 79, the control panel of the digital multi-functional peripheral displays that the setting item of the process, which cannot be executed in the set discharge tray, cannot be set on the display unit. As a result, the user can confirm the setting item of the process which cannot be executed in the discharge tray set depending on the input of the discharge tray button. Furthermore, when the discharge tray selected by the automatic setting mode is set, the setting of the discharge tray may be changed depending on the setting of the printing process. That is, when the setting of the discharge tray is the automatic setting mode, whenever the setting of the printing process is input, the setting may be changed to the discharge tray selected by the automatic setting mode.

Next, the description will be given of an example in which there is a limit on the discharge tray that can be selected depending on the setting contents of the printing process.

As described above, in the setting of the printing process, the usable discharge trays are limited. For example, the finishing process can be executed only when the discharge tray 33 is set. For this reason, in the digital multi-functional peripheral, when the finishing process (stapling, the hole punch, sorting and the like) is set, as the discharge tray, the discharge tray 31 and the discharge tray 32 cannot be selected.

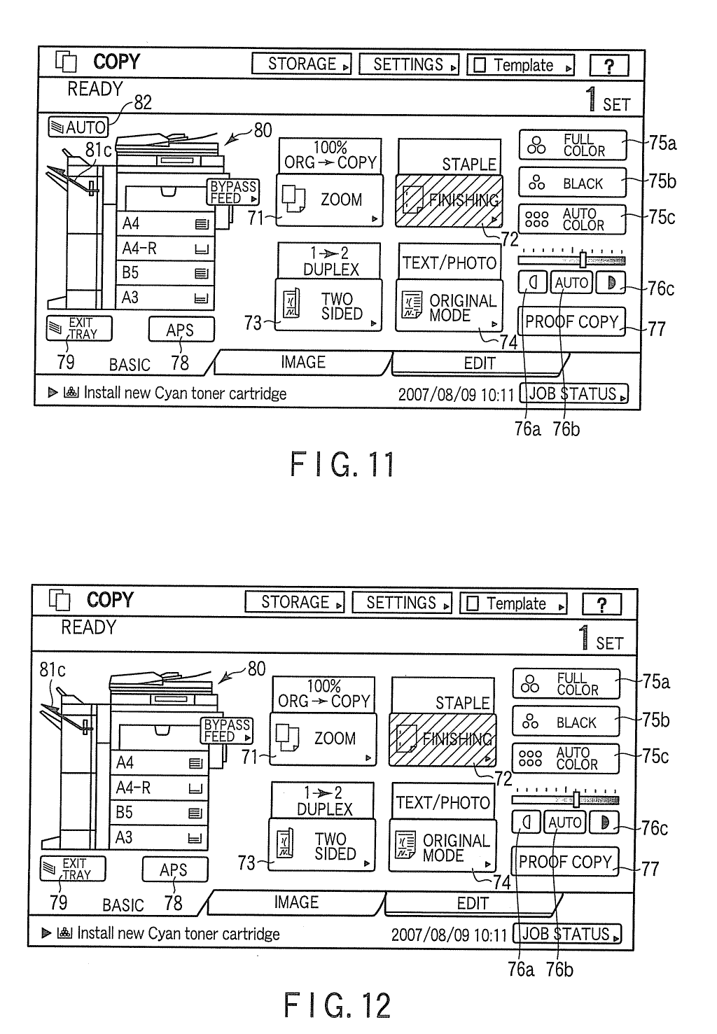

FIGS. 11 and 12 are display examples of the basic setting screen when stapling is set. In the display examples shown in FIGS. 11 and 12, the finishing button 72 is set in the selection state. When the finishing button 72 is in the selection state, the selectable discharge tray is only the discharge tray 33. For this reason, even if the user presses the discharge tray button 79, the main controller 50 does not change the setting of the discharge tray 33. Whenever the discharge tray button 79 is pressed, the display unit 41 sequentially displays the instructions showing the discharge tray 33 selected in the automatic setting mode and the instructions showing the directly designated discharge tray 33.

In other words, when the finishing process is set (when the finishing button 72 is in the selection state), the discharge tray 31 and the discharge tray 32 cannot be selected. For this reason, whenever the discharge tray button 79 is pressed, the display unit 41 alternately changes and displays the screen showing that the discharge tray 33 is set by the automatic setting mode and the screen showing that the discharge tray 33 is directly set.

FIG. 11 is a display example of the basic setting screen showing that the discharge tray 33 is set by the automatic setting mode. Furthermore, FIG. 12 is a display example of the basic setting screen showing that the discharge tray 33 is directly set. In the display example shown in FIG. 11, the display unit 41 displays the instruction icon 82 showing that the setting of the discharge tray is the automatic setting mode, and displays the discharge tray button 79 in the non selection state. In the display example shown in FIG. 12, the display unit 41 does not display the instruction icon 82, but displays the discharge tray button 79 in the selection state. In the state in which the finishing process is set, whenever the discharge tray button 79 is pressed, the display unit 41 may alternately display the setting screens shown in FIGS. 11 and 12.

As described above, in the state in which the printing process is set such that there is a limit on the useable discharge tray, the control panel of the digital multi-functional peripheral sequentially changes and displays the setting of the usable discharge tray whenever the discharge tray button is pressed. In the digital multi-functional peripheral, since the discharge tray, which cannot be used in the setting contents of the printing process, is not selected or is not displayed as a selection candidate, the user effectively performs the setting operation of the discharge tray.

Next, the setting process of the discharge tray in the digital multi-functional peripheral will be described.

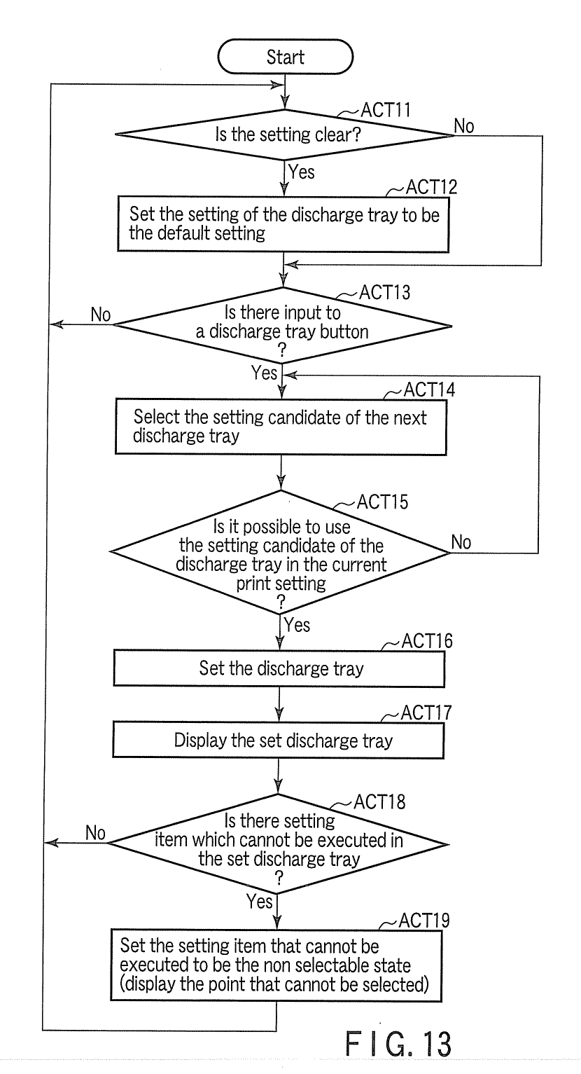

FIG. 13 is a flow chart for illustrating the flow of the setting process of the discharge tray.

The main controller 50 stores the setting contents of the copying (printing) process including the setting of the discharge tray in a memory 51b. When the copying process is executed, the main controller 50 executes the copying process according to the setting contents stored by the memory 51b.

When the setting contents stored by the memory 51b are cleared (ACT 11, YES), the main controller 50 sets the setting of the discharge tray in the default setting (ACT 12). For example, when the user inputs the resetting button 43l of the control panel 4, the main controller 50 clears the setting contents stored by the memory 51b. For example, the default setting is a setting which is based on default setting information stored by a nonvolatile memory 51a. Moreover, default setting information for each user may be stored. When the user is certified by the user certification process, the main controller 50 may set the setting of the discharge tray in the default setting based on default setting information of the user in which the certification is successful.

When the user presses the discharge tray button 79 (ACT 13, YES), the main controller 50 selects the setting candidate of the next discharge tray (ACT 14). The setting candidate of the discharge tray is selected in a predetermined order whenever the discharge tray button 79 is pressed. For example, the setting candidate of the discharge tray can be set to select in the order of “the discharge tray selected in the automatic setting mode”, “the discharge tray (the first discharge tray) 31 as the discharge unit in the main body of the digital multi-functional peripheral”, “the discharge tray (the second discharge tray) 32 as the discharge unit in the upper part of the finisher 3”, and “the discharge tray (the third discharge tray) 33 as the discharge unit that can execute the finishing process”.

When the setting candidate of the next discharge tray is selected, the main controller 50 determines whether or not the setting candidate of the selected next discharge tray is the discharge tray capable of being used in the current print setting (ACT 15). For example, when the setting contents of the printing process are the setting including the finishing process, the main controller 50 determines the discharge tray other than the discharge tray 33, in which the finishing process can be executed, is unusable. Furthermore, when the print setting is the setting including the paper of A3 size, the main controller 50 determines the discharge tray, to which the paper of A3 size cannot be discharged, is unusable.

When it is determined that the setting candidate of the selected discharge tray is the discharge tray which cannot be used in the current print setting (ACT 15, NO), the main controller 50 returns to ACT 14 and selects the setting candidate of the next discharge tray.

When it is determined that the setting candidate of the selected discharge tray is the discharge tray which can be used in the current print setting (ACT 15, YES), the main controller 50 sets the setting candidate of the selected next discharge tray to be the setting of the discharge tray (ACT 16). When setting the discharge tray, the main controller 50 displays the discharge tray which is set on the basic setting screen displayed by the display unit 41 (ACT 17). For example, the main controller 50 displays the discharge tray which is set by the display example of the basic setting screen shown in FIGS. 5 to 8.

When setting the discharge tray, the main controller 50 determines whether or not there exists a setting item of the printing process which cannot be executed in the set discharge tray (ACT 18). For example, in the discharge tray 31 and the discharge tray 32, the finishing process cannot be executed. For this reason, when the discharge tray 31 and the discharge tray 32 are set, the main controller 50 determines that the setting item regarding the finishing process is a setting item of the non executable printing process. In addition, the paper of A3 size cannot be discharged to the discharge tray 31. For this reason, when the discharge tray 31 is set, the main controller 50 determines that the setting item of the paper of A3 size is the setting item of a non executable printing process.

When there exists a setting item of the printing process which cannot be executed in the set discharge tray (ACT 18, YES), the main controller 50 sets the setting item of the non executable printing process in the non selectable state (ACT 19). For example, when the discharge tray 32 is set, as shown in FIG. 9, the main controller 50 displays the finishing button 72 in the non selectable state. Furthermore, when the discharge tray 31 is set, as shown in FIG. 10, the main controller 50 displays the finishing button 72 and the A3 cassette in the non selectable state.

In addition, in the automatic setting mode, the discharge tray is selected depending on the setting contents of the printing process. For this reason, when the setting of the discharge tray is the automatic setting mode, the main controller 50 may omit the processes of ACT 18 and ACT 19.

As described above, the digital multi-functional peripheral of the present embodiment has a plurality of discharge trays, one discharge tray button for selecting one discharge tray from the plurality of discharge trays, and a display unit. When the input to the discharge tray button is detected, the digital multi-functional peripheral sequentially sets a discharge unit for selecting depending on the setting contents of the printing process (copy process) and a discharge unit for sequentially selecting from the plurality of discharge units, and displays information showing the set discharge unit on the display unit. According to the digital multi-functional peripheral of the present embodiment, the user can sequentially change the automatic setting mode of the discharge tray and the direct designation of the respective discharge trays, only by pressing one discharge tray button.

In addition, the digital multi-functional peripheral of the present embodiment displays the illustration of the overall digital multi-functional peripheral including the plurality of discharge units on the display unit on the control panel, and displays the mark showing the set discharge tray on the illustration. The user can confirm the discharge unit which is set by the mark such as arrow that is displayed on the illustration of the entire digital multi-functional peripheral displayed on the display unit on the control panel in an overlapping manner.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming device comprising:
an image forming unit configured to form an image on an image forming medium;
a plurality of discharge units configured to discharge the image forming medium on which the image is formed by the image forming unit;
a display unit configured to display a setting screen of an image forming process by the image forming unit;
a discharge unit button configured to select one discharge unit from the plurality of discharge units;
a discharge setting unit configured to sequentially set the discharge unit selected depending on setting contents of the image forming process and the discharge unit sequentially selected from the plurality of discharge units, if the discharge unit button is pressed; and
a display controller configured to display information, which shows the discharge unit set by the discharge setting unit, on the setting screen.

2. The device according to claim 1, further comprising:
a touch panel configured to detect a part which was touched on a display screen of the display unit,
wherein the discharge unit button is an icon that is displayed on the display unit.

3. The device according to claim 1,
wherein, if the discharge setting unit sets the discharge unit selected depending on the setting contents of the image forming process, the display controller displays that the setting of the discharge unit is an automatic setting mode.

4. The device according to claim 1,
wherein the display unit displays an illustration of the image forming device including the plurality of discharge units on the setting screen, and
the display controller displays a mark on a display part of the discharge unit that is set by the discharge setting unit in the illustration.

5. The device according to claim 1,
wherein the mark is an animation showing an appearance of the image forming medium discharged from the discharge unit set by the discharge setting unit.

6. The device according to claim 1,
wherein the display unit displays the setting screen that has setting buttons of a plurality of image forming processes including the discharge unit button, and
the display controller displays the setting button of the processes, which cannot be executed in the discharge unit set by the discharge setting unit, in a non selectable state.

7. The device according to claim 1,
wherein the display unit displays the setting screen having the image forming setting button that includes the discharge unit button and a setting button of a finishing process, and
the display controller sets the setting button of the finishing process in the non selectable state, if the discharge unit set by the discharge setting unit cannot execute the finishing process.

8. The device according to claim 1,
wherein the discharge setting unit sequentially sets the discharge unit other than the discharge unit, that cannot be selected in the setting contents of the image forming process, if the discharge unit button is pressed.

9. An operating device for setting an image forming device comprising:
a display unit configured to display a setting screen of an image forming process;
a discharge unit button configured to select one discharge unit from a plurality of discharge units that can discharge paper with a image formed thereon; and
a display controller configured to sequentially display the discharge unit selected depending on setting contents of the image forming process and the discharge unit sequentially selected from the plurality of discharge units on the setting screen, if the discharge unit button is pressed.

10. The device according to claim 9, further comprising:
a touch panel configured to detect a part which was touched on a display screen of the display unit,
wherein the discharge unit button is an icon that is displayed on the display unit.

11. The device according to claim 9,
wherein the display controller displays that the setting of the discharge unit is an automatic setting mode, if the discharge setting unit sets the discharge unit selected depending on the setting contents of the image forming process.

12. The device according to claim 9,
wherein the display unit displays an illustration of the image forming device including the plurality of discharge units on the setting screen, and
the display controller displays a mark on a display part of the discharge unit that is set by the discharge setting unit in the illustration.

13. The device according to claim 9,
wherein the mark is an animation showing an appearance of the image forming medium discharged from the discharge unit set by the discharge setting unit.

14. The device according to claim 9,
wherein the display unit displays the setting screen that has setting buttons of a plurality of image forming process including the discharge unit button, and
the display controller displays the setting button of the processes, which cannot be executed in the discharge unit set by the discharge setting unit, in a non selectable state.

15. The device according to claim 9,
wherein the display unit displays the setting screen having the image forming setting button that includes the discharge unit button and a setting button of a finishing process, and
the display controller sets the setting button of the finishing process in the non selectable state, if the discharge unit set by the discharge setting unit cannot perform the finishing process.

16. The device according to claim 9,
wherein the discharge setting unit sequentially sets the discharge unit other than the discharge unit, that cannot be selected in the setting contents of the image forming process, whenever the discharge unit button is pressed.

17. A method of setting an image forming device which has a plurality of discharge units for discharging an image forming medium with an image formed thereon comprising:
detecting an input to a discharge unit button for selecting one discharge unit from the plurality of discharge units;
sequentially setting the discharge unit selected depending on setting contents of a image forming process and the discharge unit sequentially selected from the plurality of discharge units if the input to the discharge unit button is detected; and
displaying information showing the set discharge unit on a display device.

18. The method according to claim 17, further comprising:
detecting a part which was touched on a display screen of the display device unit,
wherein the discharge unit button is an icon that is displayed on the display device, and
the detection of the input to the discharge button detects touching of a display part of the icon on the display screen of the display device.

19. The method according to claim 17,
wherein information showing the set discharge unit and that the setting of the discharge unit is an automatic setting mode are displayed, if the discharge unit selected depending on the setting contents of the image forming process is set.

20. The method according to claim 17,
wherein an illustration of the image forming device including the plurality of discharge units is displayed on the display device, and
information showing the set discharge unit is a mark that is displayed on a display part of the set discharge unit in the illustration.
